(19) United States
(12) Patent Application Publication
(10) Pub. No.: US 2013/0046415 A1
(43) Pub. Date: Feb. 21, 2013

(54) PROGRAMMABLE POWER MANAGEMENT CONTROLLER

(71) Applicant: PETER M. CURTIS, Bethpage, NY (US)

(72) Inventor: PETER M. CURTIS, Bethpage, NY (US)

(21) Appl. No.: 13/571,879

(22) Filed: Aug. 10, 2012

Related U.S. Application Data
(60) Provisional application No. 61/524,045, filed on Aug. 16, 2011.

(51) Int. Cl. G06F 1/26

(52) U.S. Cl. 700/297

(57) ABSTRACT

A system for managing power in a facility includes a hardware interface with a plurality of access ports for connecting with a utility power grid, at least one renewable power source, and at least one electrical load. A plurality of sensor devices monitors power conditions at the plurality of access ports. A storage device stores one or more control programs. A microprocessor controls the hardware interface to enable or disable each of the plurality of access ports in accordance with the one or more control programs and the monitored power conditions of the access ports. An interface device receives instructions from a user and modifying the one or more control programs stored in the storage device based on the received instructions.

### CROSS-REFERENCE TO RELATED APPLICATION

The present application is based on provisional application Ser. No. 61/524,045, filed Aug. 16, 2011, the entire contents of which are herein incorporated by reference.

### TECHNICAL FIELD

The present disclosure relates to power management and, more specifically, to a programmable power management controller and a method for operating the same.

### DISCUSSION OF THE RELATED ART

Facilities, such as industrial, commercial, and residential buildings, utilize electrical power primarily from a municipal power supply grid. However, the use of alternative supplies of power is becoming widespread. These alternative supplies of power include, for example, green energy sources such as photovoltaic (PV) cell arrays and wind farms as well as fossil fuel generators. As these alternative supplies of power may be insufficient to fully satisfy the energy requirements of the facility they are installed within, it is often necessary to employ a mixed-approach to energy consumption whereby green energy sources are used to the extent available. To the extent that the green energy sources are insufficient, the municipal power supply grid may be relied upon to compensate for the difference between the supply of power from the green energy sources and the energy demanded by the facility.

Moreover, when the supply of power from green energy sources exceeds the energy demanded by the facility, it is possible for the excess energy to be sold back to the municipal power supply grid.

The electrical infrastructure required for integrating this complex arrangement of green and conventional power sources to satisfy the demands of facility load must be uniquely designed for the particular facility, taking into account the unique set of alternative and conventional power sources available to the facility and the facility's load requirements. Moreover, when a new power source is added to the facility, the electrical infrastructure may have to be redesigned to accommodate the change.

### SUMMARY

A system for managing power in a facility includes a hardware interface with a plurality of access ports for connecting with a utility power grid, at least one renewable power source, and at least one electrical load. A plurality of sensor devices monitors power conditions at the plurality of access ports. A storage device stores one or more control programs. A microprocessor controls the hardware interface to enable or disable each of the plurality of access ports in accordance with the one or more control programs and the monitored power conditions of the access ports. An interface device receives instructions from a user and modifying the one or more control programs stored in the storage device based on the received instructions.

The hardware interface may include a synchronizing hardware unit for each of the plurality of access ports. Each of the plurality of access ports may be configured to receive or dispense power to any one of the utility power grid, the renewable power source, or the electrical load. An anti-islanding device may be connected between the utility power grid and the hardware interface. The plurality of access ports of the hardware interface may be configured to connect with a plug-in electric vehicle, a photovoltaic array, a wind turbine, an energy storage device, or an internal combustion generator. The plurality of sensor devices may include a voltage monitor for monitoring a voltage of the plurality of access ports, a current monitor for monitoring a current of the plurality of access ports, an impedance meter for monitoring impedance of the plurality of access ports, a power meter for monitoring power of the plurality of access ports, an energy meter for monitoring energy of the plurality of access ports, or a temperature sensor for monitoring temperature of the plurality of access ports.

The storage device may be a flash memory. The microprocessor may include a system-on-chip or a workstation. The microprocessor may utilize associated hardware and software for reading the plurality of sensor devices, analyzing the readings from the plurality of sensor devices, and controlling the interface device. The microprocessor may control the hardware interface to enable or disable each of the plurality of access ports in accordance with data received from a second system for managing power in a second facility.

The second system for managing power in the second facility may include a second hardware interface with a plurality of access ports for connecting with a utility power grid, at least one renewable power source, and at least one electrical load, a second plurality of sensor devices for monitoring power conditions at the plurality of access ports, a second storage device for storing one or more control programs, a second microprocessor for controlling the hardware interface to enable or disable each of the plurality of access ports in accordance with the one or more control programs and the monitored power conditions of the access ports, and a second interface device for receiving instructions from a user and modifying the one or more control programs stored in the storage device based on the received instructions.

The microprocessor may control the hardware interface to enable or disable each of the plurality of access ports in accordance with data received from the Internet. The data received from the Internet may include weather forecast data or sensor data from a second system for managing power in a second facility. The interface device may establish a web portal that the user may access using a web browser for creating, modifying or replacing the one or more control programs stored in the storage device or for viewing system parameters.

The one or more control programs stored in the storage device may include an energy distribution plan. The one or more control programs stored in the storage device may includes steps for determining that power is available from the utility power grid, deploying available power from the at least one renewable power source to satisfy the at least one electrical load, and, when it is determined that power is available from the utility power grid, deploying power from the utility power grid, to supplement the power from the at least one renewable power source, to the extent necessary to satisfy the at least one electrical load.

The one or more control programs stored in the storage device may include steps for determining an extent to which power from the at least one renewable power source is available to satisfy the at least one electrical load. When it is determined that the at least one renewable power source is insufficient to satisfy the at least one electrical load one or more of the at least one electrical loads characterized as non-critical or low-priority may be cut so that the power from the at least one renewable power source is sufficient to satisfy a remaining load. When it is determined that the at least one renewable power source is more than sufficient to satisfy the at least one electrical load, a relative value in storing excess power from the at least one renewable power source for later use may be assessed versus selling the excess power to the utility power grid. Excess power may be transferred from the at least one renewable power source to an energy storage device connected to the hardware interface. The excess power may be sold to the utility power grid, based on the results of the assessment.

The assessing may include forecasting a future demand of the at least one electrical load, assessing an ability to store and retrieve power within the energy storage device, and assessing a value for selling excess power to the utility power grid.

A system for managing power in a facility includes a hardware interface with a plurality of access ports and synchronizing hardware units for connecting with a utility power grid, at least one renewable power source, an internal combustion generator, and at least one electrical load. A plurality of sensor devices monitors power conditions at the plurality of access ports. A microprocessor controls the hardware interface to enable or disable each of the plurality of access ports by sending instructions to the synchronizing hardware units in accordance with an energy distribution plan and the monitored power conditions of the access ports. An interface device receives instructions from a user and modifying the energy distribution plan.

The microprocessor may control the hardware interface to enable or disable each of the plurality of access ports in accordance with data received from a second system for managing power in a second facility. The second system may include a second hardware interface with a plurality of access ports for connecting with a utility power grid, at least one renewable power source, and at least one electrical load, a second plurality of sensor devices for monitoring power conditions at the plurality of access ports, a second storage device for storing one or more control programs, a second microprocessor for controlling the hardware interface to enable or disable each of the plurality of access ports in accordance with the one or more control programs and the monitored power conditions of the access ports, and a second interface device for receiving instructions from a user and modifying the one or more control programs stored in the storage device based on the received instructions.

A system for managing power in a facility includes an electrical switchgear with a plurality of access ports for connecting with a utility power grid, at least one renewable power source, an internal combustion generator, and at least one electrical load. A plurality of sensor devices monitors power conditions at the plurality of access ports. A microprocessor controls the hardware interface to enable or disable each of the plurality of access ports in accordance with an energy distribution plan and the monitored power conditions of the access ports. An interface device receives instructions from a user and modifying the energy distribution plan. The energy distribution plan defines at least three modes of operation including a normal mode in which the switchgear, under the control of the microprocessor, maintains a connection to the utility power grid and disconnects the internal combustion generator, a green backup mode in which the switchgear, under the control of the microprocessor, disconnects the utility power grid and disconnects the internal combustion generator, and a generator backup mode in which the switchgear, under the control of the microprocessor, disconnects the utility power grid and maintains a connection to the internal combustion generator.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a schematic diagram illustrating a hardware interface and interconnecting system components providing a fully integrated power management system in accordance with exemplary embodiments of the present invention.

FIG. 2 is a flow diagram illustrating energy distribution plans for managing the facility power system for optimal efficiency in accordance with exemplary embodiments of the present invention;

FIG. 3 is a schematic diagram illustrating a normal mode of operation in accordance with exemplary embodiments of the present invention;

FIG. 4 is a schematic diagram illustrating a green backup mode of operation in accordance with exemplary embodiments of the present invention;

FIG. 5 is a schematic diagram illustrating a “generator backup mode” of operation in accordance with exemplary embodiments of the present invention;

FIG. 6 is a schematic diagram illustrating a manual/maintenance mode of operation in accordance with exemplary embodiments of the present invention;

FIG. 7 is a schematic diagram illustrating a microgrid module in accordance with an exemplary embodiment of the present invention; and

FIG. 8 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention relate to a programmable power management controller for managing a plurality of available energy supplies, both conventional and green, and for distributing the supplied energy to satisfy load demand for a facility. The programming of the power management controller may be altered, either automatically or manually, to accommodate changes in the set of available energy supplies, for example, the addition of a new power source, without the need for extensive re-engineering of the power circuitry.

The programmable power management controller according to exemplary embodiments of the present invention may be integrated into a facility such as a residential, commercial or industrial building. Each available power source, including both conventional and green sources, may be connected as inputs to the programmable power management controller and the electrical load of the facility may be connected as outputs. The programmable power management controller may be configured, as desired; to accommodate the particular inputs and outputs and accordingly, the engineering design process associated with installing the power sources may be simplified. In this way, the programmable power management controller may provide an integrated and resilient infrastructure management solution. The programmable power management controller may then provide load management for the facility's electrical load, may monitor the sources of power and the various loads for information that may be used to enhance efficiency, and may provide for a greater degree of energy security, which may be, for example, the dependency of the power supply. Moreover, exemplary embodiments of the present invention may be easily modified to accommodate changes in the sources of electrical power or load.

Exemplary embodiments of the present invention may utilize a programmable power management controller embodied as a microgrid module. The microgrid module may include a hardware interface for receiving power from each available energy source and a microgrid master controller for routing power from the hardware interface to the facility load and for collecting and acting upon sensor data generated from a plurality of sensors installed within the hardware interface. The microgrid master controller may include a microprocessor device, for example, a central processing unit (CPU) of a computer system.

Exemplary embodiments of the present invention may also include a battery management system for controlling one or more battery arrays installed to the hardware interface. The battery management system may operate to rout available power to charge the batteries and/or to rout power from the batteries to drive or contribute to the driving of the facility load. The battery management system may use the sensor data to make control decisions that maximize the operational efficiency of the batteries.

By providing circuitry for connecting to a wide variety of power sources and by making use of programmable control, exemplary embodiments of the present invention may be flexible enough to be used with a wide range of facilities without requiring extensive customization or configuration.

Moreover, by routing power from multiple sources and by storing/retrieving power from battery arrays, exemplary embodiments of the present invention may provide for a consistent and reliable supply of power that may contribute to the reliability and resiliency of the supply of power to the facility's electrical loads.

Unlike existing systems which may only permit the incorporation of one renewable energy source in powering a facility's electrical load, exemplary embodiments of the present invention are configured to receive power from a plurality of electrical power sources, such as wind turbines, solar photovoltaic cells, and/or fuel cells. Utilizing several renewable sources may increase overall system reliability and flexibility.

By providing comprehensive management and control of the energy sources and loads, exemplary embodiments of the present invention may maximize system efficiency, reduce energy costs, and prevent downtime by simplifying the interfacing of several alternative energy sources with conventional energy sources. Exemplary embodiments of the present invention may also collect data from internal sensors and external sources so that electrical management may be coordinated in light of various events, both internal to and external to the facility. For example, programmable power management controllers in accordance with exemplary embodiments of the present invention may receive data from both internal sensors and from a wide area network, such as the Internet. The received data may then be used to maximize energy efficiency.

For example, programmable power management controllers from one facility may connect with similar programmable power management controllers from a set of other facilities to exchange sensor data and/or operating conditions so that each programmable power management controller may increase operational efficiency based on the experience and knowledge of other similar systems.

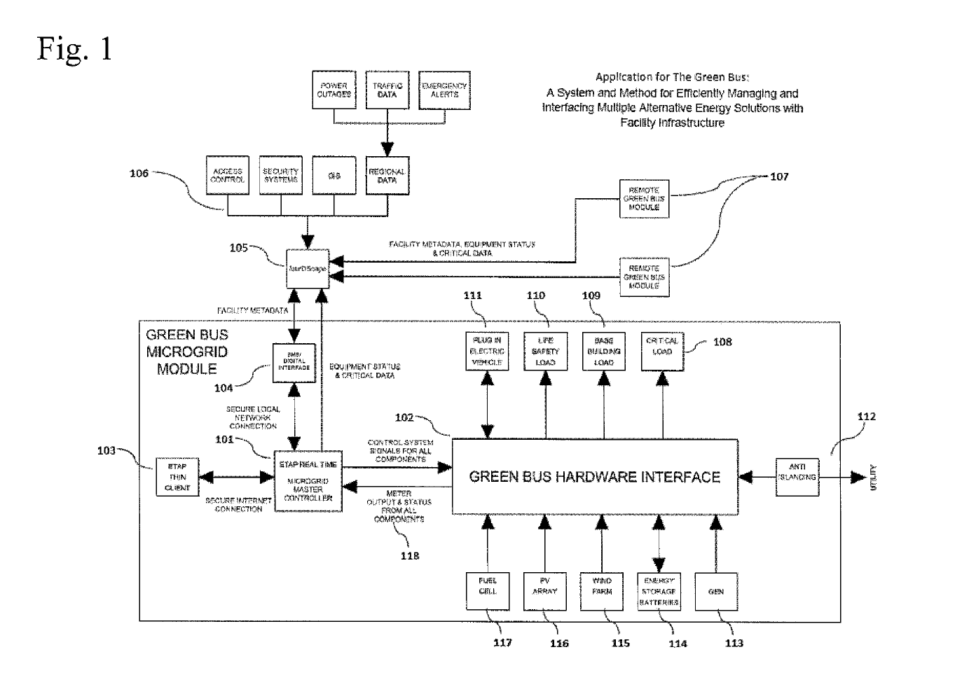

FIG. 1 is a schematic diagram illustrating a hardware interface and interconnecting system components providing a fully integrated power management system. The configuration of the system's hardware and the operation of the migrogrid master controller are shown.

A hardware interface 102 is responsible for receiving power from various green and conventional power sources and distributing power to various facility loads. All power sources and loads available at the time of initial installation may be connected to the microgrid master controller through the hardware interface 102. Subsequently, as new power sources are installed to the facility, they may be connected to the hardware interface 102.

A microgrid master controller 101 manages and controls the hardware interface 102. The microgrid master controller 101 may collect system data information, for example, from a plurality of sensors installed within the power sources and loads. The microgrid master controller 101 may utilize this data locally in the routing of power and/or may send out this data over a web interface 103, which may be, for example, a thin client. The system data information may also be provided to a computerized electronic building monitoring and control system (building management system) or digital interface that may be installed in commercial and industrial facilities 104 and common operating environment such as a geospatial information system (GIS) 105. The microgrid master controller 101 may include a user interface for permitting one or more users to program/configure one or more energy distribution plans. From the user interface, a user may also access various system components in a control panel format. System data may be displayed in control panel, report, table, and chart formats. The user may connect to the user interface of the microgrid master controller 101 via the web interface thin client 103, for example, using a web browser.

The hardware interface 102 may include a remotely operable switchgear that acts as a paralleling gear for interconnecting alternative and conventional energy sources as well as the system loads. The hardware interface 102 may also seamlessly integrate energy storage batteries 114, fuel cells 117, photovoltaic arrays 116, wind turbines 115, utility power, and generator sources 113 through the use of inverters. Utility power may be received by the hardware interface 102 through an anti-islanding device 112. The anti-islanding device 112 may function to keep the facility electrical system disconnected and isolated from the electrical grid of the utility in the event of a power failure so that the facility may continue to receive power safely from its own distributed power sources.

Each of the above-mentioned components may be intelligently switched on or off with one or more electrically operated disconnects located within, or connected to, the hardware interface 102 by commands generated by the microgrid master controller 101.

The power flow characteristics of each component attached to the hardware interface 102 may be continuously monitored by a plurality of sensor devices. Examples of sensor devices that may be used include voltage meters, current meters, impedance meters, power meters, energy meters, infrared temperature sensors, thermocouples, signal analyzers, etc. The collected sensor data may be sent to the master controller 101 for interpretation and analysis. The plurality of sensor devices may include, for example, metering or monitoring devices 118.

Real time data from each monitoring device may establish operating conditions and the status of each component. This data may be logged, for example, by the microgrid master controller 101. The monitoring devices may be attached to the microgrid master controller 102 via industry standard connection methods.

External data may be provided to the microgrid master controller 101 via the common operating environment 105. For example, weather forecasts, operating data provided by other facilities, etc. may be received by the microgrid master controller 101 to aid in the intelligent routing of power. The weather forecast data may include temperature predictions which may affect battery charging efficiency, wind conditions, which may affect wind turbine output, and cloud cover, which may affect PV array output. This data may be used in accordance with the energy distribution plans so that temporary disruptions in green power supply may be accommodated, for example, by using the stored energy in the available battery arrays.

Power may be supplied by any combination of alternative power sources such as fuel cells 117, photovoltaic panels 116, wind turbines 115, and energy storage devices 114. A utility source and standby generator 113 may also be used to supplement the alternative power sources to the extent that the facility load exceeds the combined capacity of the alternative power sources. One or more hybrid and/or plug-in electric vehicles 111 may also be attached to the hardware interface 102 for the charging of the vehicle and/or to provide additional power to the system as needed. The hardware interface 102 may also include voltage regulation circuitry to harness power from smaller DC devices including 12V, 18V, and 36V power sources (not shown).

The hardware interface 102 may, under the command of the microgrid master controller 101, rout power from the available energy sources to the load of the facility. The load of the facility may include, for example, life safety loads 110, critical loads, 108, and the base building load 109. Life safety loads may include electrical loads that could endanger human life in the event of a power failure. Critical loads may include loads that are deemed critical by the facility owner/operator. Loss of such loads may cause a serious impact to business operations and/or monetary losses. Base building loads include all other electrical loads not covered under life safety and critical loads.

Each load may be attached to the hardware interface 102. The microgrid master controller 101 may intelligently manage all loads and keep the facility operating at maximum efficiency, for example, using load shedding and peak shaving whenever possible, in accordance with the programmed energy distribution plans.

While the hardware interface 102 may be connected to a utility feed, generator, and critical load, the hardware interface 102 may also be connected to one or more alternative power sources. The load of the facility may also be connected to the hardware interface 102 via multiple circuits so that each load circuit may be prioritized and may be shed at the command of the Microgrid Master Controller 101.

The anti-islanding device 112 may be used to safely isolate the facility power system from the utility power grid in the event of a power disruption and a voltage detection system, installed to the incoming utility power line may be used by the Microgrid Master Controller 101 to determine when the utility power feed has returned. When it is determined that the utility power feed has returned, the anti-islanding device 112 may restore the power connection to the gird.

The Microgrid Master Controller 101 may also interface with the building management system (BMS)/digital interface 104, the web interface 103, and the common operating environment interface 105, for example, over a computer network, using secure encrypted network connections. The online web portal 103 may provide access to facility information from anywhere, for example, in a comprehensive read only format. Accessing the common operating environment 105 may permit a user to view data from multiple remote modules 107 and correlate it with many other forms of external regional data 106 such as access control data, security system data, geospatial information system data, and regional data. Regional data may include, for example, power outage data, traffic data, and/or emergency alert data.

Each remote module 107 may be a complete programmable power management controller system that may be networked with a number of other complete programmable power management controller systems through the common operating environment. The common operating environment may provide access to data from any one (local) system to any other one (remote) system.

The microgrid master controller 101 may interface with the BMS 104 to allow the microgrid master controller 101 to send alarms, status updates, and/or other data feeds to the common operating environment interface 105.

Together, the hardware interface 102 and the microgrid master controller 101 may form a microgrid module. The microgrid module may also include the web interface 102, the anti-islanding device 112, the BMS/digital interface 104, and the metering/monitoring devices 118. The load elements and/or power source elements 108-117 may be considered to be external to the microgrid module. The microgrid module in association with the remaining elements illustrated in FIG. 1, may be considered to be the facility's power system, which may be referred to herein simply as “the system.”

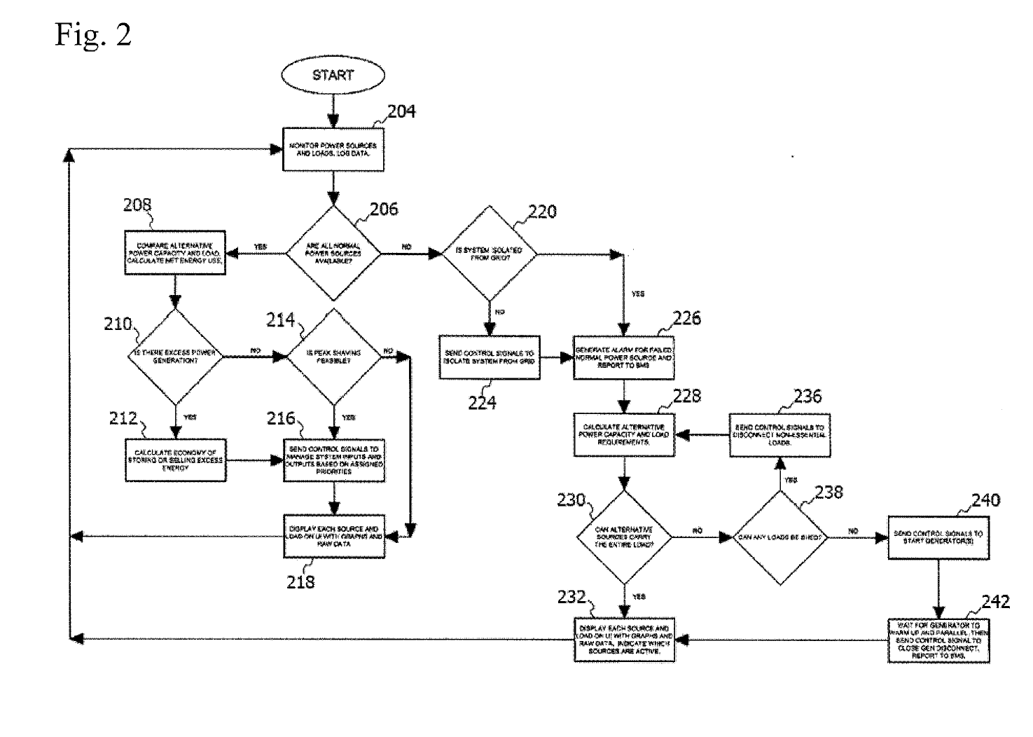

FIG. 2 is a flow diagram illustrating energy distribution plans for managing the facility power system for optimal efficiency in accordance with exemplary embodiments of the present invention. It is to be understood, however, that the energy distribution plans may be fully programmable and may be utilized by the microgrid master controller 101 for managing the manner in which energy is received and distributed by the hardware interface 102. The hardware interface 102, operating under the procedure defined by the energy distribution plan, is capable of making calculations, sending control signals, displaying graphs and data on the user interface (UI), and reporting to the building management system (BMS)/digital interface.

Each of the power source and load components may be monitored and logged (Step S204). As described above, monitoring may be performed by the set of sensors installed within the hardware interface 102. As the sensor data is reported back to the microgrid master controller 101, the microgrid master controller 101 may log the received sensor data to a database. Next, it may be determined whether normal power is available (Step S206). Normal power may be defined as the power received from the utility power grid. This determination may be made, for example, by monitoring the voltage at the point in which the utility power grid electricity reaches the facility, for example, at the anti-islanding module 112. If normal power is available (Yes, Step S206), then the microgrid master controller 101 may compare the alternative power capacity with the load requirements and calculate the extent to which the alternative power capacity can satisfy the load requirements of the facility (Step S208). It may then be determined if the available power capacity exceeds the load requirements (Step S210). If the available power capacity does exceed the load requirements (Yes, Step S210), then the economy of storing or selling excess energy may be calculated (Step S212).

The flow of power from source to load may then be adjusted according to the energy distribution plan by sending, from the microgrid master controller 101 to the hardware interface 102, appropriate control signals (Step S216). For example, where it is determined that it is economically viable to sell excess power capacity back to the utility, power may be so routed at the hardware interface and where it is determined that it is economically viable to store the excess power capacity for future use, power may be routed at the hardware interface from the alternative sources to the energy storage batteries.

Power flow adjustments controlled by the microgrid controller and executed by the hardware interface may be based on equipment priorities specified by the user. Accordingly, where the amount of power generated from alternative sources is not in excess of the load (No, Step S210), it may be determined whether peak shaving is feasible and/or economically viable (Step S214). Peak shaving may be the selective disconnecting of loads so that alternative power generated may be sufficient to power the remaining online load. Where peak shaving is feasible (Yes, Step S214), the microgrid master controller may rout power through the hardware interface accordingly (Step S216) and may therefore remove non-critical loads per the peak shaving user-defined settings. Where peak shaving is not feasible, or the peak shaving that is feasible is insufficient to bring the total load to within the capacity alternative energy capacity (No, Step S214), the UI may be updated to display each power source and each load as raw data and/or as graphs (Step S218) and the power system configuration may remain unchanged. Thereafter, the process may repeat with the monitoring of the power sources and loads (Step S204).

Where normal power is not available (No, Step S206), for example, in the event of a blackout on the electrical grid, it may be determined whether the electrical system of the facility is isolated from the utility grid (Step S220). If the system is in fact isolated from the utility grid (Yes, Step S220), a failed normal power source alarm may be generated and the system may send one or more reports to the building management system/digital interface (Step S226). These alarms/reports may be used to ensure awareness of the condition of the utility grid so that contingency arrangements may be made. If the system is not isolated from the utility grid (No, Step S220), then appropriate control signals may be sent to the hardware interface 102 to isolate the system from the utility grid (Step S224) before proceeding to step S226. This feature may prevent islanding during a power failure. Islanding describes a condition where during a utility power failure; a facility with distributed generation becomes a power island, energizing local power lines that would otherwise be de-energized due to the failure. This can pose a risk to utility workers dispatched to service the outage.

The alternative power capacity and load requirements may then be recalculated in analysis of the loss of utility grid power (Step S228). The quantity of available alternative power may then be compared with the facility load (Step S230). If alternative power sources can carry the entire load (Yes, Step S230), then the system may update the user interface and display each source and load with graphs and raw data, as well as indicating which sources are active (Step S232).

If the load exceeds the alternative power capacity (No, Step S230), then the system may determine whether any load can be shed (Step S238). If load can be shed (Yes, Step S238), then control signals may be sent to disconnect non-essential and/or low priority loads (Step S236), and then the process may return to Step 228. If load cannot be shed (No, Step S238), then the computer system may send control signals to start one or more generators (Step S240). The computer system may then wait for the generator to warm up and parallel, then it may send a control signal to attach the generator to the hardware interface and report to the building management system/digital interface (Step S242). The paralleling process may include adjusting the rotational speed of the generator such that its sinusoidal alternating current waveform is in sync with the utility waveform.

The process may then continue to Step S232 to display updated data on the user interface. After Step S232, the system may return to Step S204 and the process may be repeated.

The microgrid master controller may enter one of a number of various modes of operation depending upon the detected state of the available power and loads. The various modes of the microgrid master controller may be defined by programming and its operation may be customized through user selectable options.

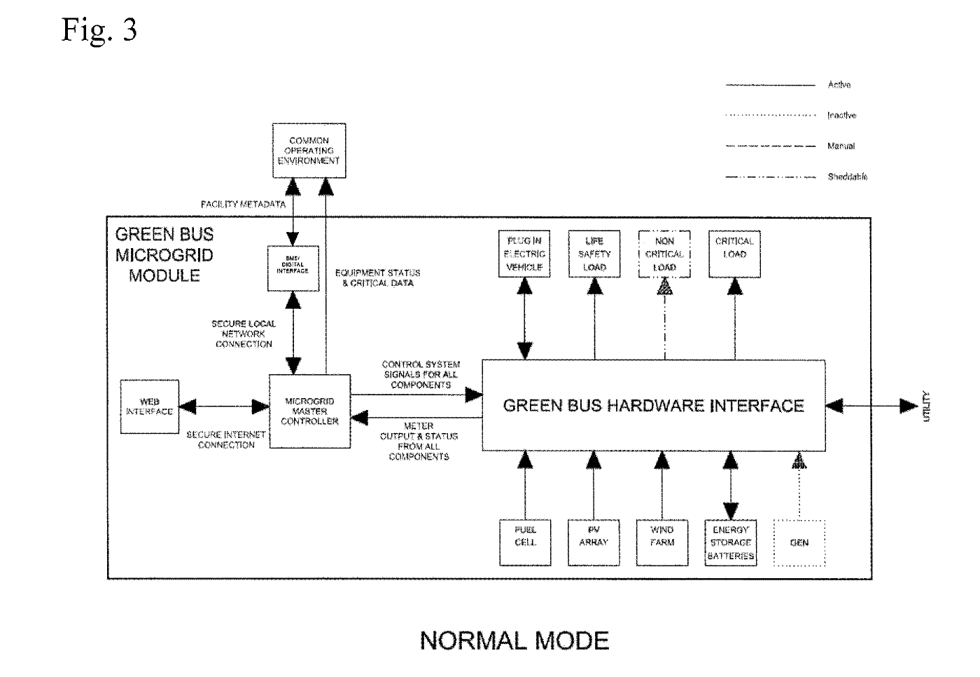

FIG. 3 is a schematic diagram illustrating a “normal mode” of operation in accordance with exemplary embodiments of the present invention. Here, the normal mode may be defined as having an available and active utility power supply. In this mode, alternative energy sources may be supplemented, to the extent necessary, by power from the utility power grid. The normal mode may be adopted as a standard mode of operation when all components are functional.

As may be seen from this figure, the generator connected to the hardware interface may remain inactive and non-critical load and/or load having a lower priority may be schedulable as desired to minimize energy consumption, however, besides this, all critical load may remain active.

In the normal mode, if the alternative energy sources are producing enough power to completely support the load, the system may either allow excess power to be sold back to the utility or stored in the battery bank for later use on-site. This decision may be made based on the programmable software logic described in detail above.

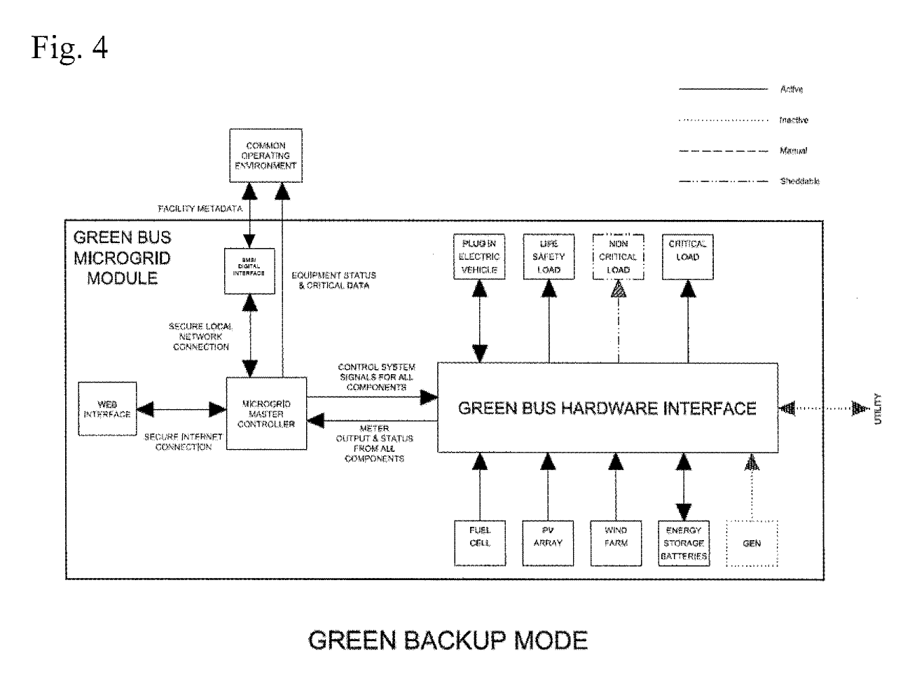

FIG. 4 is a schematic diagram illustrating a “green backup mode” of operation in accordance with exemplary embodiments of the present invention. The green backup mode is one in which the utility power becomes unavailable, for example, due to a blackout, and the alternative power sources are sufficient to support all load. Here, as shown, the utility power grid may be disconnected, the generator may remain inactive, and the non-critical and/or lower priority load may be scheduled. The microgrid master controller may enter this mode upon determining that the utility power has failed and the quantity of available alternative power is sufficient to meet either the entire desired load, or is sufficient to meet an actual load as a result of non-critical load scheduling. The microgrid master controller may implement this mode, for example, by commanding the hardware interface to disconnect from the utility power grid and, where necessary, to implement scheduling of the non-critical load.

Once the microgrid master controller has identified that the utility power has been restored, the green backup mode may end and the normal mode is restored, for example, by reconnecting the utility power. If the alternative energy sources are not capable of supporting the entire load, the system may attempt to shed low priority loads until there is sufficient alternative power capacity to support the remaining load. Load priorities may be assigned by the user during initial configuration and/or at any time load is added to the system.

If the alternative sources cannot support the load after load shedding attempts, the system may switch to a generator backup mode to make up for the power shortage.

During the analysis period in which the system determines how the load demanded may be satisfied, an energy storage component may supplement the alternative sources to ensure that critical system loads will remain online if the alternative sources are not producing sufficient power.

When the utility power is restored, the system may parallel with the grid before closing the utility feed. The microgrid master controller may send the generator a signal to shut down and the system may return to the normal mode.

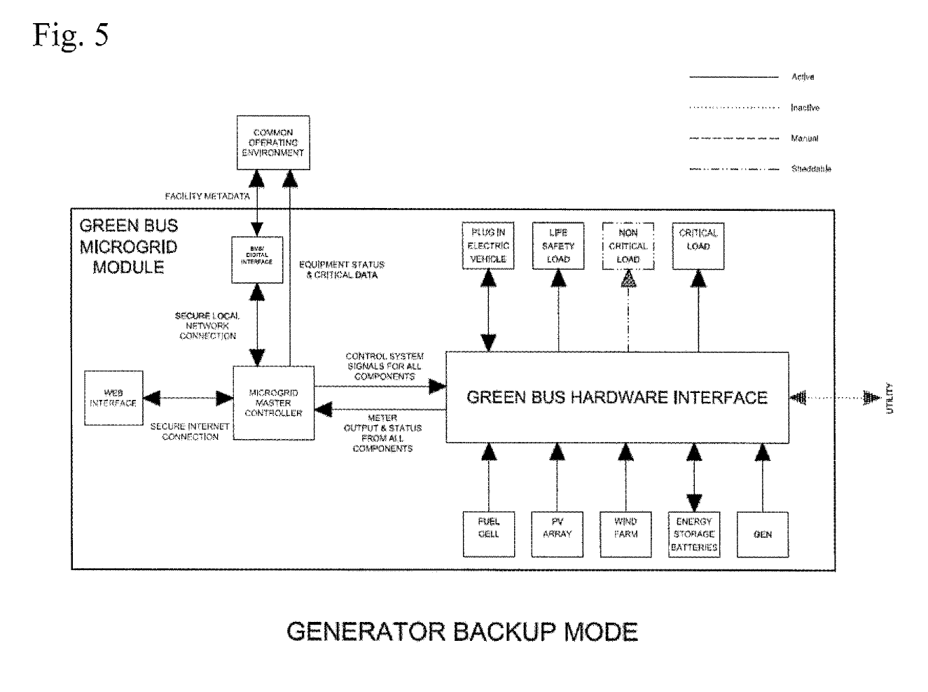

FIG. 5 is a schematic diagram illustrating a “generator backup mode” of operation in accordance with exemplary embodiments of the present invention. This mode may be enabled when the utility power is lost and it is determined, by the microgrid controller, that even with the shedding of all non-critical load, the quantity of available power from alternative sources is insufficient to satisfy load demand.

As may be seen in this figure, if the utility input fails and the alternative energy sources are not capable of supporting all load, the utility power may be isolated from the system and the microgrid master controller may signal the generator to start. When it is determined that the utility has returned, the system may switch back to the normal mode and shut down the generator.

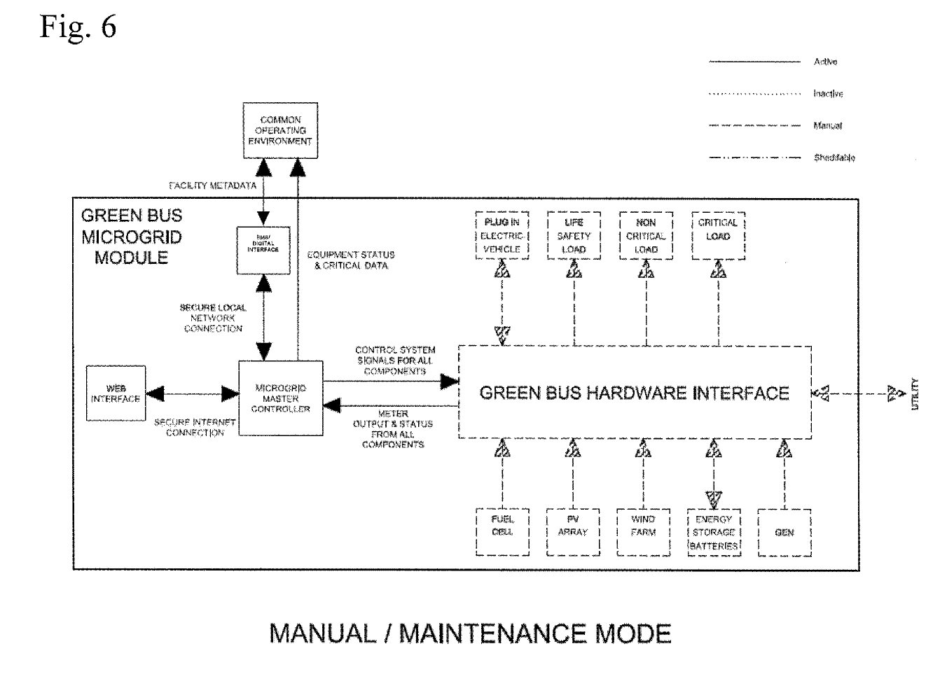

FIG. 6 is a schematic diagram illustrating a “manual/maintenance mode” of operation in accordance with exemplary embodiments of the present invention. The manual/maintenance mode may be manually activated by a user. While this mode is activated, the logic programming of the microgrid master controller may be suspended. All inputs and outputs may then be controlled manually. A system administrator password check may be employed to authenticate a valid user prior to entering the manual/maintenance mode.

Under this mode, when an action is attempted, the microgrid master controller, in coordination with the user interface, may perform a simulation of the effects of the action for review and request confirmation from the user to commit the changes. If the action poses a risk to the system critical load, a second prompt may be confirmed with an administrator password.

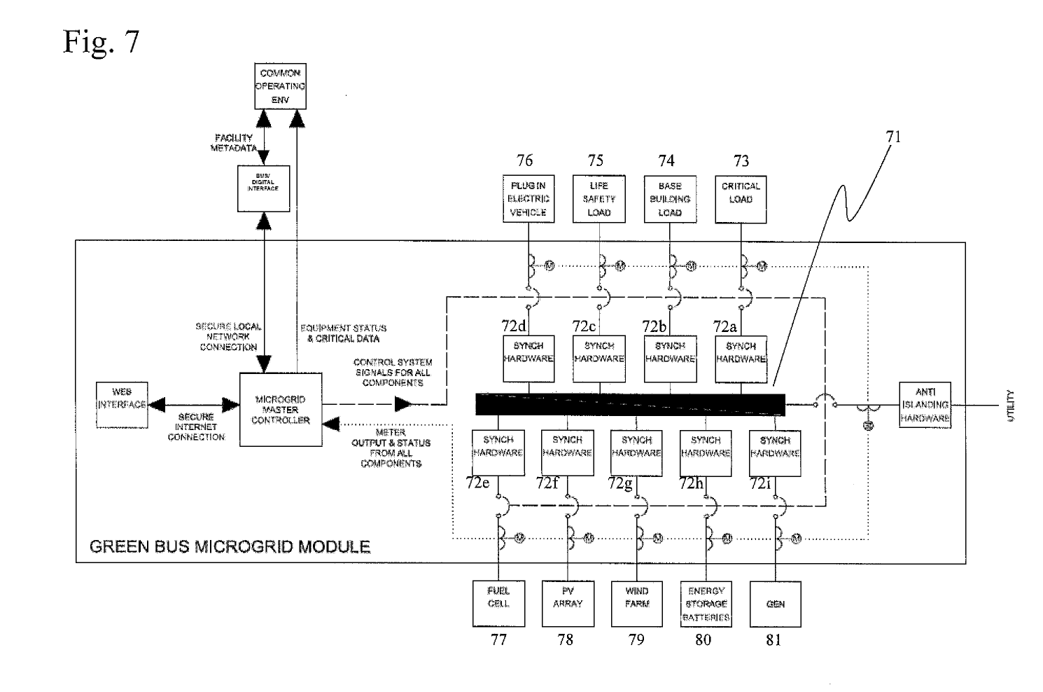

FIG. 7 is a schematic diagram illustrating a microgrid module in accordance with an exemplary embodiment of the present invention. According to the depicted configuration, the web interface 103, the microgrid master controller 101, the hardware interface, and the anti-islanding hardware may be included within the microgrid module. The BMS 104, the common operating environment 105, and the loads 108-111 and power sources 113-117 may all be external to the microgrid module. The hardware interface may include a switchgear bus 71 and a plurality of synchronizing devices 71(a)-72(j) for connecting and disconnecting each load/power source object. While exemplary embodiments of the present invention are illustrated in the accompanying figures as including ten load/power source objects including three load objects 108-110, an electric vehicle object 111, a generator object, three alternative power source objects 115-117 and one battery object 114, the invention is not limited to the configuration shown. The hardware interface may include any number of object connections, for example, there may be less than ten such connections, between ten and twenty connections, or greater than twenty connections. Each object connection may be used for any type of object; be it alternative power source, conventional power source, load, battery, etc.

The microgrid master controller may include a compact computer system such as a system-on-chip architecture in which one or more computer components are included in a single package. Alternatively, or additionally, the microgrid master controller may include a storage device for storing control programs such as flash memory, a central processing unit (CPU) for processing control programs, a memory device such as SDRAM, a data storage device for storing control programs, and a network interface card for allowing the microgrid master controller to interface with the web interface/thin client. The control programs stored on the storage device may be used by the CPU for controlling the operation of the hardware interface. The control programs stored on the storage device may be reprogrammed, replaced, modified, or erased.

Exemplary embodiments of the present invention may employ a common operating environment interface that may permit a user to correlate local data with data from multiple other microgrid modules or power systems installed at other, for example, similar, facilities. The information may be shared over the Internet with communication being handled securely either on a peer-to-peer basis or via a microgrid communication web service. By sharing information across multiple microgrid modules, individual microgrid modules may be made aware of the scope and scale of a power grid disruption and/or an emergency situation. This shared data may therefore be used by the logical programming of the microgrid master controller to influence power utilization and generation. For example, if it is determined, based on the shared information, that a wide-spread emergency is occurring, additional tiers of load may be shed to conserve generator fuel supplies. For example, an emergency load may be defined and all load besides the emergency load may be shed in the event of an emergency in which alternative power is insufficient to satisfy high-priority load.

Such programming may be particularly useful for military, mission critical, C4ISR (Command, Control, Communications, Computers, Intelligence, Surveillance and Reconnaissance) and Emergency Response Operations Center applications. The common operating environment may be configured to display data from any number of subsystems of sensor networks, camera feeds, or any other data stream. This fully customizable geographic data may be utilized by the microgrid master controller to intelligently assess all microgrid module installations to influence how each microgrid module is affected by external events. Operations may therefore be managed efficiently to utilize the most reliable installation during an emergency situation.

As an alternative or supplement to the use of an Internet connection for sharing information between microgrid modules, a satellite mobile uplink may be used to establish a connection to a centralized command center. The command center may run common operating environment software that may allow for remote control of the microgrid module, for example, when placed into a mobilized state in response to an emergency situation. A local instance of the common operating environment may also be available at each mobilized module to provide real time data to personnel at the module site. In the event of a loss of the satellite uplink, the mobilized module may continue to function independently by making use of the software running locally on the device. Exemplary embodiments of the present invention may utilize the microgrid master controller to continuously monitor the condition of one or more backup power supplies, e.g., uninterruptible power supply (UPS) systems, which may be directly linked to the hardware interface. In such an arrangement, notifications may be generated by the microgrid master controller when situations that threaten the viability of the system are detected. Such situations may include battery capacity depletion and an increase in load that may compromise the ability of the generator and the alternative sources of power to maintain the load in the event of a blackout.

For example, considering the subsystem redundancy requirements, a maximum load with redundancy L may be calculated as:

$$L = \frac{{C}_{N} ( M - {R}_{C} )}{{R}_{S}} \qquad ( eq . 1 )$$

where the capacity of each redundant module C_{N}, the number of redundant modules M, the specified component redundancy R_{C}, and the specified subsystem redundancy R_{S} may be evaluated.

The component redundancy R_{C} may be defined as the number of additional redundant components within the system, beyond the absolute minimum N required to support the system load. This value may be represented as:

(N+R_{C}) (eq. 2)

The system redundancy R_{S} may be defined as the number of parallel systems, each of which is capable of supporting the entire load, and may represented as:

R_{S}(N+R_{C}) (eq. 3)

Using these equations, the actual system load may be compared to the capacity of the redundant subsystem to provide a real-time assessment of the subsystem redundancy. Warnings may be provided in the form of alarms as the load grows and approaches the threshold where redundancy will be affected by further increases in load. The system may also display the calculated system redundancy as the load changes, to provide an accurate representation of the reliability of the system.

Exemplary embodiments of the present invention may be customized to meet the needs of the particular facility. For example, large scale facilities and/or commercial data centers, which may have loads on the order of hundreds of kW to several MW may utilize redundant microgrid master controller modules to ensure maximum availability of the system. The overall system capacity may be deployed small and expanded as facility needs grow.

Smaller scale business and/or residential facilities may utilize microgrid modules that feature a single microgrid master controller with weatherproofing for installation outdoors. Such a device may be scalable, for example, up to 50 kW to minimize costs yet still provide a reliable power management solution.

Exemplary embodiments of the present invention may comprise a complete power management solution including microgrid module, one or more remote microgrid modules, and a common operating environment, in combination with one or more energy sources including but not limited to photovoltaic panels, a wind turbines, battery backup, fuel cells and generators. Each such energy source may have a power capacity, for example, of 50 kW per module. Multiple energy sources may be placed in parallel for installments requiring a higher power output.

The microgrid modules may be installed either by directly wiring the system into a facility's electrical infrastructure to provide power during an emergency situation and as a supplement to its normal utility power supply. Alternatively, a portable version of the system may provide power to a number of electrical devices via an attached power strip.

The portable microgrid modules according to exemplary embodiments of the present invention may be constructed of rugged lightweight components that can withstand the physical stresses of transportation. Optional features may include armor plating, high heat tolerance components, and/or redundant microgrid master controllers.

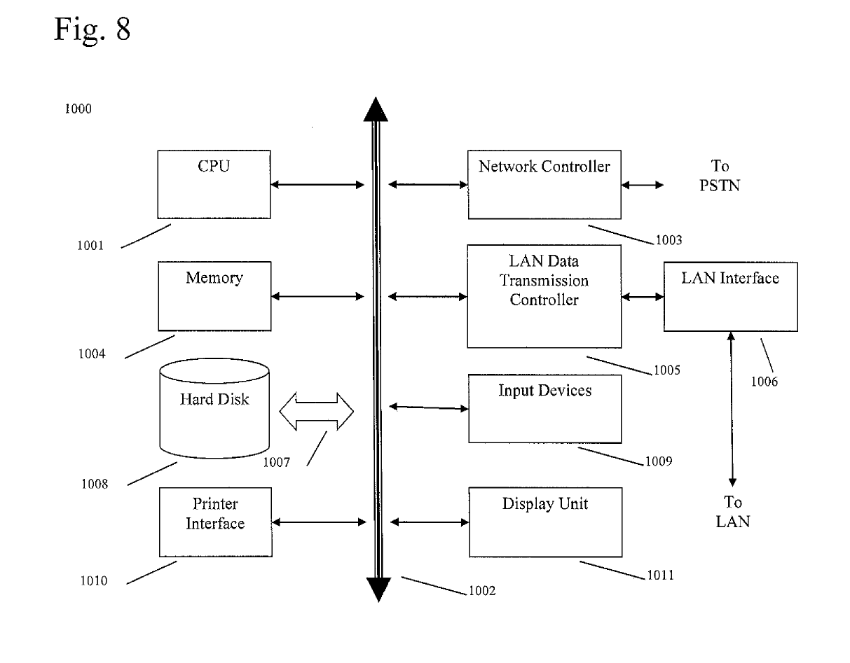

FIG. 8 shows an example of a computer system which may be included within the microgrid master controller in accordance with exemplary embodiments of the present invention. The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A system for managing power in a facility, comprising:
a hardware interface with a plurality of access ports for connecting with a utility power grid, at least one renewable power source, and at least one electrical load;
a plurality of sensor devices for monitoring power conditions at the plurality of access ports;
a storage device for storing one or more control programs;
a microprocessor for controlling the hardware interface to enable or disable each of the plurality of access ports in accordance with the one or more control programs and the monitored power conditions of the access ports; and
an interface device for receiving instructions from a user and modifying the one or more control programs stored in the storage device based on the received instructions.

2. The system of claim 1, wherein the hardware interface includes a synchronizing hardware unit for each of the plurality of access ports.

3. The system of claim 1, wherein each of the plurality of access ports is configured to receive or dispense power to any one of the utility power grid, the renewable power source, or the electrical load.

4. The system of claim 1, further including an anti-islanding device connected between the utility power grid and the hardware interface.

5. The system of claim 1, wherein the plurality of access ports of the hardware interface are configured to connect with a plug-in electric vehicle, a photovoltaic array, a wind turbine, an energy storage device, or an internal combustion generator.

6. The system of claim 1, wherein the plurality of sensor devices includes a voltage monitor for monitoring a voltage of the plurality of access ports, a current monitor for monitoring a current of the plurality of access ports, an impedance meter for monitoring impedance of the plurality of access ports, a power meter for monitoring power of the plurality of access ports, an energy meter for monitoring energy of the plurality of access ports, or a temperature sensor for monitoring temperature of the plurality of access ports.

7. The system of claim 1, wherein the storage device is a flash memory.

8. The system of claim 1, wherein the microprocessor comprises a system-on-chip or a workstation.

9. The system of claim 1, wherein the microprocessor utilizes associated hardware and software for reading the plurality of sensor devices, analyzing the readings from the plurality of sensor devices, and controlling the interface device.

10. The system of claim 1, wherein the microprocessor controls the hardware interface to enable or disable each of the plurality of access ports in accordance with data received from a second system for managing power in a second facility.

11. The system of claim 10, wherein the second system for managing power in the second facility comprises:
a second hardware interface with a plurality of access ports for connecting with a utility power grid, at least one renewable power source, and at least one electrical load;
a second plurality of sensor devices for monitoring power conditions at the plurality of access ports;
a second storage device for storing one or more control programs;
a second microprocessor for controlling the hardware interface to enable or disable each of the plurality of access ports in accordance with the one or more control programs and the monitored power conditions of the access ports; and
a second interface device for receiving instructions from a user and modifying the one or more control programs stored in the storage device based on the received instructions.

12. The system of claim 1, wherein the microprocessor controls the hardware interface to enable or disable each of the plurality of access ports in accordance with data received from the Internet.

13. The system of claim 12, wherein the data received from the Internet includes weather forecast data or sensor data from a second system for managing power in a second facility.

14. The system of claim 1, wherein the interface device establishes a web portal that the user can access using a web browser for creating, modifying or replacing the one or more control programs stored in the storage device or for viewing system parameters.

15. The system of claim 1, wherein the one or more control programs stored in the storage device includes an energy distribution plan.

16. The system of claim 1, wherein the one or more control programs stored in the storage device includes steps for:
determining that power is available from the utility power grid;
deploying available power from the at least one renewable power source to satisfy the at least one electrical load; and
when it is determined that power is available from the utility power grid, deploying power from the utility power grid, to supplement the power from the at least one renewable power source, to the extent necessary to satisfy the at least one electrical load.

17. The system of claim 1, wherein the one or more control programs stored in the storage device includes steps for:
determining an extent to which power from the at least one renewable power source is available to satisfy the at least one electrical load;
when it is determined that the at least one renewable power source is insufficient to satisfy the at least one electrical load, cutting one or more of the at least one electrical loads characterized as non-critical or low-priority so that the power from the at least one renewable power source is sufficient to satisfy a remaining load; and
when it is determined that the at least one renewable power source is more than sufficient to satisfy the at least one electrical load, the following steps are performed:
assessing a relative value in storing excess power from the at least one renewable power source for later use versus selling the excess power to the utility power grid; and
storing excess power from the at least one renewable power source to an energy storage device connected to the hardware interface or selling the excess power to the utility power grid, based on the results of the assessment.

18. The system of claim 17, wherein the assessing includes:
forecasting a future demand of the at least one electrical load;
assessing an ability to store and retrieve power within the energy storage device; and
assessing a value for selling excess power to the utility power grid.

19. A system for managing power in a facility, comprising:
a hardware interface with a plurality of access ports and synchronizing hardware units for connecting with a utility power grid, at least one renewable power source, an internal combustion generator, and at least one electrical load;
a plurality of sensor devices for monitoring power conditions at the plurality of access ports;
a microprocessor for controlling the hardware interface to enable or disable each of the plurality of access ports by sending instructions to the synchronizing hardware units in accordance with an energy distribution plan and the monitored power conditions of the access ports; and
an interface device for receiving instructions from a user and modifying the energy distribution plan.

20. The system of claim 19, wherein the microprocessor controls the hardware interface to enable or disable each of the plurality of access ports in accordance with data received from a second system for managing power in a second facility, comprising:
a second hardware interface with a plurality of access ports for connecting with a utility power grid, at least one renewable power source, and at least one electrical load;
a second plurality of sensor devices for monitoring power conditions at the plurality of access ports;
a second storage device for storing one or more control programs;
a second microprocessor for controlling the hardware interface to enable or disable each of the plurality of access ports in accordance with the one or more control programs and the monitored power conditions of the access ports; and
a second interface device for receiving instructions from a user and modifying the one or more control programs stored in the storage device based on the received instructions.

21. A system for managing power in a facility, comprising:
an electrical switchgear with a plurality of access ports for connecting with a utility power grid, at least one renewable power source, an internal combustion generator, and at least one electrical load;
a plurality of sensor devices for monitoring power conditions at the plurality of access ports;
a microprocessor for controlling the hardware interface to enable or disable each of the plurality of access ports in accordance with an energy distribution plan and the monitored power conditions of the access ports; and
an interface device for receiving instructions from a user and modifying the energy distribution plan,
wherein the energy distribution plan defines at least three modes of operation including:
a normal mode in which the switchgear, under the control of the microprocessor, maintains a connection to the utility power grid and disconnects the internal combustion generator;
a green backup mode in which the switchgear, under the control of the microprocessor, disconnects the utility power grid and disconnects the internal combustion generator; and
a generator backup mode in which the switchgear, under the control of the microprocessor, disconnects the utility power grid and maintains a connection to the internal combustion generator.
